(19) United States
(12) Patent Application Publication
(10) Pub. No.: US 2017/0049089 A1
(43) Pub. Date: Feb. 23, 2017

(54) FISHING TACKLE STORAGE DEVICE

(71) Applicant: Brett Griffith, Newtown, PA (US)

(72) Inventor: Brett Griffith, Newtown, PA (US)

(21) Appl. No.: 15/243,951

(22) Filed: Aug. 22, 2016

Related U.S. Application Data
(60) Provisional application No. 62/207,979, filed on Aug. 21, 2015.

(51) Int. Cl. A01K 97/06

(52) U.S. Cl. CPC A01K 97/06

(57) ABSTRACT

A storage device is disclosed for fishing tackle may include a case with a case shaft substantially in the center of the case. At least one spool may have a center shaft opening that may be configured to allow the case shaft to pass through the center shaft opening. The at least one spool may include a core configured to receive and retain fishing hooks.

### CLAIM OF PRIORITY UNDER 35 U.S.C. §§119 (e)

This application claims priority to U.S. provisional application Ser. No. 62/207,979 titled “FISHING TACKLE STORAGE DEVICE” and filed Aug. 21, 2015; which application is incorporated herein in its entirety.

### BACKGROUND

1. Technical Field

This disclosure relates to storage devices for fishing tackle.

2. Background Art

Many people who fish know the challenge of having multiple fishing hooks, fishing flies, and fishing lures together and have them become tangled with each other. Many fishing lures come in a bag that are not suitable for storing the fishing lure once the fishing lure has been used. A conventional tackle box does not sufficiently prevent tangling of fishing lures connected to a leader. Fishing tackle can be stored in re-sealable plastic bags, but if the fishing tackle is not thoroughly dried, then the water or moisture in the bag can rust or damage the fishing tackle. Another method of dealing with fishing tackle is to leave the tackle on the fishing rod, but this method does not allow for changing the tackle based on the fish, and also does not protect the tackle or people from accidental injury if they contact the tackle while transporting the fishing rod with the tackle. The lack of good options for storing tackle increases the cost to an angler, as many fishing tackle are used once or only a few times before they become damaged or unusable, when they could be used many times. Many methods of storing fishing tackle do not allow for efficient organization of fishing tackle, and therefore waste time for the angler as they must search for the right tackle when there is a need to change fishing tackle. There is a need for a fishing tackle holder to allow fishing lures to be stored without becoming tangled and damaged.

### BRIEF DESCRIPTION OF THE DRAWINGS

FIG. 1 is a side view according to some embodiments of a case for storing fishing tackle.

FIG. 2 is a side view according to some embodiments of an open case for storing fishing tackle.

FIG. 3 is a side view according to some embodiments of a spool for storing fishing tackle.

FIG. 4 is an exploded view according to some embodiments of a spool for storing fishing tackle.

FIG. 5 is a side perspective view according to some embodiments of a spool for storing fishing tackle.

### DETAILED DESCRIPTION

In some embodiments the disclosed fishing tackle holders may solve problems in the prior art by making the process of storing, accessing and maintaining fishing tackle much more efficient. The disclosed tackle holders may make the fishing experience more enjoyable and may enable anglers to change tackle much faster than with some previous methods.

FIG. 1 shows an example tackle storage device 100 for storing fishing tackle according to some embodiments. The tackle storage device 100 may have a case 112 and may include a clip 110, and a zipper 116. A weight holder 118 may include through openings 120 that may be used to retain weights 122 with swivels 124. The case 112 may be made from a material 114 that is waterproof. In some embodiments the material 114 may include closed-cell neoprene. In some embodiments the material 114 may include material that is breathable, including open-cell neoprene.

FIG. 2 shows an example case 112 in an open position according to some embodiments. The case may include a case shaft 136 on the inside of the case 112. The case may have two halves with each half having parts of a zipper 116. The zipper 116 may be a waterproof zipper, or a zipper that is not waterproof.

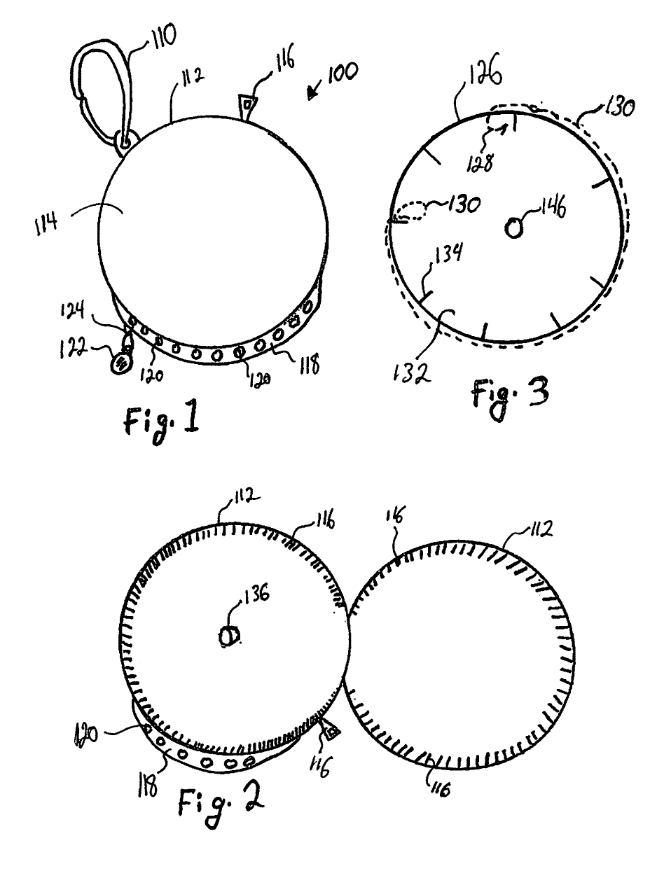

FIG. 3 shows an example spool 126 for storing fishing tackle according to some embodiments. The spool may have a ridged plate 132 with notches 134. Fishing tackle, including a fishing hook 128 may be attached to and stored on the spool as described below, with a leader 130 wrapped around the spool 126. The end of the leader 130 may be secured in a notch 134.

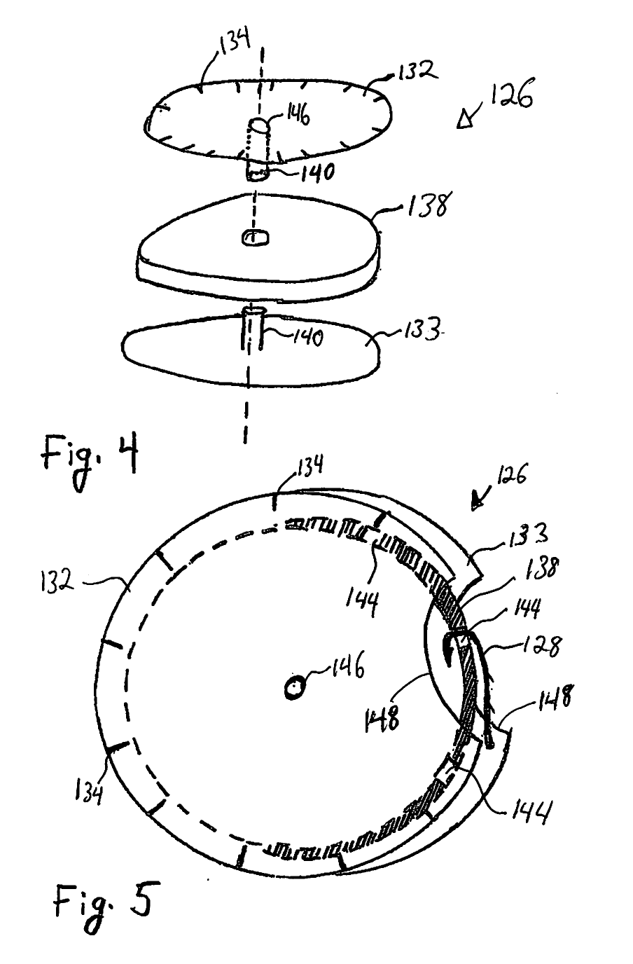

FIG. 4 shows an example exploded view of a spool 126 according to some embodiments. The spool 126 may have a top plate 132, and a bottom plate 133. The top plate 132 and bottom plate 133 may have a plate shaft 140 that extends through a core 138 disposed between the plates 132 and 133. In some embodiment the top plate 132 and bottom plate 133 may be assembled with a snap action so that the shafts snap together by pressing the plates towards each other. The core 138 may be a material suitable for retaining a fishing hook, including foam, felt, or other soft material. In some embodiments the core 138 is made from plastic or other hard material with openings, ridges or other structures for hook 128 to rest on. A hook 128 may be held in place against a ridge or edge of the core 138 by the leader 130 that is held taut when a portion of the leader 130 is connected into a notch 134.

The spool 126 may have a center shaft opening 146. The center shaft opening 146 may allow the case shaft 136 to pass into or through the spool 126. The case shaft 136 may have a length so that multiple spools may be placed on the case shaft 136.

FIG. 5 shows an example spool 126 according to some embodiments. The core may include one or more core notches 144 with one or more openings in the core 138. The core notches 144 may make it easier for an angler to insert and store fishing tackle, including fishing hooks 128. The core notches 144 may have a width and a depth that allows for a hook to be inserted. In some embodiments the core notches 144 provide an edge for the hook 128 to be held against. In some embodiment the top plate 132 and the bottom plate 133 may have an access cut-away 148. In some embodiment the core 138 may have a diameter that is the same size or larger than the diameter of the plates 132 and 133. The core 138 may have a diameter that is smaller than the plates. When the core 138 has a diameter that is smaller than the plates 132 and 133, the fishing tackle may be protected by the plates when stored. Access cut-away 148 may allow for easy access to fishing tackle stored in the spool 126. The core 138 may be rotated around the plate shaft 140 so that a hook 128 or other fishing tackle inserted into the core 138 is protected.

An angler may store multiple hooks 128 in one spool 126. In some embodiments one or more fishing lures may be pre-loaded into a spool 126. Multiple spools may be used to organize fishing tackle. An angler may store multiple lures in a spool where all the lures in one spool are designed to attract and catch the same type or similar types of fish. An angler may select one spool or multiple spools and place them in a case 112, thereby allowing efficiency in organization, and allowing an angler to take with them only the fishing tackle that is needed. By having fishing tackle organized into spools an angler may save time when preparing to go fishing.

In some embodiments the case material 114 and the core 138 are made from material that is buoyant in water and will float if placed in water. The case may be waterproof to prevent water from entering the case 112. The case 112 may be breathable to allow fishing tackle to dry after being used and placed in a spool 126 in the case 112.

In some embodiments parts of the storage device 100 may have air pockets to create a buoyant storage device. For example, core 138 may be made from a plastic material with air pockets so that the spool 126 can float in water. In some embodiments the core 138 may be made from plastic material that is buoyant in water. In some embodiments the spool 126 may be made as one piece, including the core 138.

The top plate 132 and the bottom plate 133 may be made from plastic or other material suitable for a damp environment. The size and diameter of the spool 126 may be based on the size of tackle to be stored. In some embodiments a spool may have a diameter between about five inches and eight inches. A spool 126 may be designed to hold a type of fishing tackle, such as flounder, striper, bluefish or tuna rigs. In some embodiments the spool 126 may have a width of around one-quarter inch or more. The case shaft 136 may have a length of about two inches. In some embodiments a case 112 may be designed to hold six to eight spools. In some embodiments the case shaft 136 may be shorter or longer than two inches, and be designed to hold more or less than six to eight spools.

In some embodiments the case 112 may have a diameter that allows it to enclose one or more spools 126. The case 112 may have a diameter of six to ten inches, and may have a depth that allows for multiple spools to be stored.

The weight holder 118 may be made from a suitable material to retail weights. In some embodiments the weight holder 118 includes bronze materials. In some embodiments the weight holder includes plastic materials.

While the principles of the invention have been made clear in illustrative embodiments, there will be immediately obvious to those skilled in the art many modifications of structure, arrangement, proportions, and methods, the elements, materials, and components used in the practice of the invention, and otherwise, which are particularly adapted to specific environments and operative requirements without departing from those principles. The appended claims are intended to cover and embrace any and all such modifications, within the limits only of the true spirit and scope of the invention.

1. A storage device for fishing tackle comprising:
A case with a center and a case shaft substantially in the center of the case; and
At least one spool with a center shaft opening that is configured to allow the case shaft to pass through the center shaft opening, wherein the at least one spool includes a core configured to receive and retain fishing hooks.
